(19) United States
(12) Patent Application Publication
(10) Pub. No.: US 2025/0115456 A1
(43) Pub. Date: Apr. 10, 2025

(54) DELIVERING AND STORING DEVICE AND FILAMENT COILING DEVICE

(71) Applicant: JF POLYMERS (SUZHOU) CO., LTD., Suzhou (CN)

(72) Inventor: Guan LI, Suzhou (CN)

(73) Assignee: JF POLYMERS (SUZHOU) CO., LTD., Suzhou (CN)

(21) Appl. No.: 18/912,539

(22) Filed: Oct. 10, 2024

(30) Foreign Application Priority Data
Oct. 10, 2023 (CN) 2023227182192

(51) Int. Cl. B65H 67/06; B33Y 40/00; B65H 49/38

(52) U.S. Cl. CPC B65H 67/066; B65H 49/38; B65H 67/067; B33Y 40/00

(57) ABSTRACT

A delivery and storage device and a filament coiling device are provided. The delivery and storage device includes a device body, a plurality of storage bins, and a traveling assembly. The device body includes a chassis. The plurality of storage bins are disposed on the chassis and arranged in a direction parallel to the chassis. Each storage bin includes a stacking cavity and a pick-and-place opening formed in a top of the stacking cavity. The stacking cavity is configured to accommodate filament reels stacked in a direction perpendicular to the chassis and restrict the filament reels from moving in the direction parallel to the chassis. The delivery and storage device can effectively increase a number of filament reels stored, and is adaptable to an external loading and unloading mechanism which picks up a filament reel vertically.

### RELATED APPLICATIONS

The present patent claims the benefit of priority of CN 2023227182192, filed Oct. 10, 2023, which is hereby incorporated by reference in its entirety.

### TECHNICAL FIELD

The present application relates to the technical field of three-dimensional (3D) printing, and in particular, to a delivery and storage device and a filament coiling device.

### BACKGROUND

As a rapid prototyping technology, 3D printing is a forming technique of printing a digital model file into a physical object by layer-by-layer stacking forming with a high polymer and a metal as consumables based on adhesive properties thereof.

At present, common 3D printing consumables are mainly classified by a physical form into a liquid photosensitive resin material, a filament, and a powder material, where the filament needs to be wound around a special filament reel and thus is avoided from being unwound during transportation and use. In an actual printing process, a 3D printing filament reel is usually conveyed to a target area using a transfer apparatus. The transfer apparatus is generally in a structural form of a small transport cart capable of holding a plurality of filament reels at a time, and can rapidly move to the target area. The filament reels can then be placed into or picked up out of the transfer apparatus by a worker or an external loading and unloading mechanism in the target area.

A transfer apparatus in the prior art is only suitable for manually placing and picking up a filament reel arbitrarily, and is not applicable to an automatic loading and unloading mechanism that picks up a filament reel vertically.

### SUMMARY

The present application provides a delivery and storage device and a filament coiling device that can effectively increase a number of filament reels stored and are adaptable to an external loading and unloading mechanism which picks up a filament reel vertically.

To achieve the above objectives, embodiments of the present application adopt the following technical solutions:

In a first aspect, an embodiment of the present application provides a delivery and storage device. The delivery and storage device includes a device body, a plurality of storage bins, and a traveling assembly, where the device body includes a chassis, the plurality of storage bins are disposed on the chassis and arranged in a direction parallel to the chassis, each storage bin includes a stacking cavity and a pick-and-place opening formed in a top of the stacking cavity, the stacking cavity is configured to accommodate filament reels stacked in a direction perpendicular to the chassis and restrict the filament reels from moving in the direction parallel to the chassis, and the traveling assembly is disposed on the chassis to enable the device body to roll or slide.

The delivery and storage device provided by embodiments of the present application has a plurality of storage bins arranged in a direction parallel to a chassis such that filament reels are held more neatly and space is utilized more reasonably. Accordingly, the number of filament reels stored can be increased. Since a stacking cavity is capable of accommodating filament reels stacked in a direction perpendicular to the chassis, no obstruction occurs between two adjacent filament reels in a vertical direction so that the filament reels can be sequentially gripped or placed by the external loading and unloading mechanism in the vertical direction. In addition, the stacking cavity is also capable of restricting the filament reels from moving in the direction parallel to the chassis. Therefore, the positions of the filament reels are relatively fixed in the delivery and storage device such that the external loading and unloading mechanism grips the filament reels at the fixed positions each time.

According to some embodiments of the present application, a heat exchange opening is formed in a sidewall of the stacking cavity and configured to enable the filament reels in the stacking cavity to exchange heat with the outside.

According to some embodiments of the present application, the heat exchange opening extends from the top of the stacking cavity to a bottom of the stacking cavity.

According to some embodiments of the present application, the stacking cavity is defined by a plurality of limiting elements in a circumferential direction; the plurality of limiting elements extend in the direction perpendicular to the chassis; and the heat exchange opening is formed between two adjacent ones of the plurality of limiting elements.

According to some embodiments of the present application, the limiting element is of a columnar structure and/or the plurality of limiting elements are evenly distributed in the circumferential direction.

According to some embodiments of the present application, the device body further includes:
a top plate located above the chassis, where the pick-and-place opening is formed in the top plate; and
a side support located between the chassis and the top plate to connect the chassis and the top plate,
where the plurality of limiting elements are located between the top plate and the chassis; upper ends of the plurality of limiting elements are connected to the top plate; and lower ends of the plurality of limiting elements are connected to the chassis.

According to some embodiments of the present application, the side support includes a first support frame and a second support frame disposed oppositely; and two ends of the top plate are lapped on the first support frame and the second support frame, respectively.

According to some embodiments of the present application, the device body further includes a cross beam which has one end connected to a top of the first support frame and the other end connected to a top of the second support frame; and the top plate is lapped on the cross beam.

According to some embodiments of the present application, the pick-and-place opening is circular in shape, and has an inner diameter matching an outer diameter of the filament reel.

According to some embodiments of the present application, a communication opening is disposed on a side of the pick-and-place opening that corresponds to the heat exchange opening and penetrates through an edge of the top plate in a radial direction of the pick-and-place opening.

According to some embodiments of the present application, a locating identifier is disposed on the top plate; the locating identifier includes a first locating identifier and a second locating identifier; a connecting line of the first locating identifier and the second locating identifier is tilted relative to both a length direction and a width direction of the top plate; and the first locating identifier and the second locating identifier are configured for the external loading and unloading mechanism to identify a position of the delivery and storage device.

According to some embodiments of the present application, an inner diameter of the stacking cavity matches an outer diameter of the filament reel; and the plurality of storage bins are arranged in a two-dimensional array in a length direction and a width direction of the delivery and storage device.

According to some embodiments of the present application, at least one lightening hole is formed in the chassis.

According to some embodiments of the present application, a heightening seat is disposed at a bottom of the chassis and configured to increase a distance between the chassis and a ground; and the traveling assembly includes a roller disposed at a bottom of the heightening seat, where a brake apparatus is disposed on the roller.

In a second aspect, an embodiment of the present application provides a filament coiling device, including:
a rack including a loading and unloading station;
a delivery and storage device disposed at the loading and unloading station, where the delivery and storage device is the delivery and storage device according to the first aspect of the present application; and
a loading and unloading mechanism disposed on the rack and configured to pick up a filament reel in a stacking cavity of the delivery and storage device or place a filament reel in the stacking cavity in a vertical direction.

In the filament coiling device provided in the embodiment of the present application, since the delivery and storage device according to any embodiment of the first aspect is employed, according to some embodiments of the present application, a locking mechanism is disposed between the rack and the delivery and storage device, and the locking mechanism is configured to lock a position of the delivery and storage device when the delivery and storage device enters the loading and unloading station.

According to some embodiments of the present application, the loading and unloading station includes a first sidewall, a second sidewall, and a third sidewall; the first sidewall and the second sidewall are disposed oppositely; the third sidewall is connected between the first sidewall and the second sidewall; an access opening is formed at ends of the first sidewall and the second sidewall away from the third sidewall; the delivery and storage device enters the loading and unloading station through the access opening, and when the delivery and storage device is located in the loading and unloading station, the delivery and storage device abuts against the first sidewall, the second sidewall, and the third sidewall separately; the locking mechanism is disposed at the access opening; and when the locking mechanism is in a locked state, the locking mechanism prevents the delivery and storage device from moving out of the access opening.

According to some embodiments of the present application, a plurality of rollers are disposed on the first sidewall and the second sidewall; the plurality of rollers are arranged in a moving direction of the delivery and storage device to guide the delivery and storage device to move into and out of the loading and unloading station and reduce a frictional force of the delivery and storage device.

According to some embodiments of the present application, the locking mechanism includes a stop arm and a locking actuator, where the stop arm is disposed at the access opening and configured to be movable between a locking position and an unlocking position, where when the stop arm is located in the locking position, the stop arm obstructs the delivery and storage device to prevent the delivery and storage device from moving out of the access opening; and when the stop arm is located in the unlocking position, the stop arm avoids the delivery and storage device; and the locking actuator is configured to drive the stop arm to move between the locking position and the unlocking position.

According to some embodiments of the present application, the stop arm is rotatably disposed at the access opening; and the locking actuator is configured to drive the stop arm to rotate between the locking position and the unlocking position.

According to some embodiments of the present application, a locating identifier is disposed on a top plate of the delivery and storage device; and an identification apparatus is disposed on the loading and unloading mechanism and configured to identify the locating identifier to determine a position of the delivery and storage device.

### BRIEF DESCRIPTION OF THE DRAWINGS

FIG. 1 is a structural schematic diagram of a delivery and storage device provided by an embodiment of the present application;

FIG. 2 is a front view of a delivery and storage device provided by an embodiment of the present application;

FIG. 3 is a top view of a delivery and storage device provided by an embodiment of the present application;

FIG. 4 is a structural schematic diagram of a filament coiling device provided by an embodiment of the present application;

FIG. 5 is an enlarged view of the locking mechanism of FIG. 4; and

FIG. 6 is a top view of a filament coiling device provided by an embodiment of the present application.

### DETAILED DESCRIPTION

The following description provides specific application scenarios and requirements of the present disclosure, with the purpose of enabling those skilled in the art to make and use the content in the present disclosure. For those skilled in the art, various partial modifications to the disclosed embodiments are obvious, and without departing from the spirit and scope of the present disclosure, the general principles defined herein can be applied to other embodiments and application. Therefore, the present disclosure is not limited to the embodiments, but is the consistent with the widest scope of claims.

The terms used herein are merely intended to describe specific examples or embodiments, rather than to limit the present disclosure. For example, unless expressly stated otherwise, the singular forms “a”, “an” and “this” used herein may also include plural forms. In the present disclosure, the terms “include” and/or “comprise” refer to the existence of an associated integer, step, operation, element, component and/or group, without excluding the existence of one or more other features, integers, steps, operations, elements, components and/or groups. In other words, other features, integers, steps, operations, elements, components and/or groups may be added to the system/method. In this specification, the term “A is on B” may mean that A is directly adjacent to B (above or below), or that A and B are indirectly adjacent (that is, A and B are separated by an object). The term “A is in B” may mean that A is completely in B or A is partially in B.

In consideration of the following description, in the present disclosure, these and other features, the operation and function of related elements of the structure, as well as the economics of the combination and manufacturing of components can be significantly improved. With reference to the drawings, all of these form part of the present disclosure. However, it should be clearly understood that the drawings are merely intended for illustration and description purposes, rather than to limit the scope of the present disclosure.

In consideration of the following description, in the present disclosure, these and other features, the operation and function of related elements of the structure, as well as the economics of the combination and manufacturing of components can be significantly improved. With reference to the drawings, all of these form part of the present disclosure. However, it should be clearly understood that the drawings are merely intended for illustration and description purposes, rather than to limit the scope of the present disclosure. It should be understood that the accompanying drawings are not drawn to scale.

3D printing, a rapid prototyping technology, is a technology that uses bondable materials such as powdered metals or plastics to construct objects based on digital model files by printing layer by layer. The 3D printing is typically implemented by using a digital technical material printer. This technology has been applied to the fields of jewelry, shoes, industrial design, building, engineering and construction, automobiles, aerospace, dental and medical industry, education, geographic information systems, civil engineering, guns, and others.

Filament melting manufacturing is one of the most commonly used 3D printing technologies, and follows the following principle: a printing head is controlled by a computer to be put in a multi-axis compound motion, and a filament is heated to a temperature slightly above a melting point thereof in the printing head, and then extruded and sprayed through a printing head with a fine nozzle. Currently, a hardware structure of a 3D printer available on the market for printing using the filament melting manufacturing technology generally includes a filament conveying apparatus, a printing head, a heating apparatus, a printing head driving apparatus, a worktable, and the like. At present, common 3D printing consumables are mainly classified by a physical form into a liquid photosensitive resin material, a filament, and a powder material, where the filament needs to be wound around a special filament reel and thus is avoided from being unwound during transportation and use. Therefore, a filament transporting apparatus is typically a filament reel transfer apparatus.

The transfer apparatus is generally in a structural form of a small transport cart capable of holding a plurality of filament reels at a time, and can rapidly move to the target area. No matter whether the filament reel is conveyed during the production of 3D printing filaments or during the use of 3D printing filaments, a number of filament reels stored in the transfer apparatus needs to be increased as much as possible. The conveying efficiency is improved and the conveying frequency is reduced. Meanwhile, in order to improve the efficiency of picking up or placing filament reels, the filament reels may be picked up or placed by an external loading and unloading mechanism 260 instead of manual work.

However, filament reels are placed on an existing transfer apparatus arbitrarily, and positions of the filament reels on a delivery and storage device are not fixed. Consequently, it is difficult for the external loading and unloading mechanism 260 to automatically pick up filament reels. Moreover, the space utilization is not reasonable such that a small number of filament reels are stored.

In view of this, some embodiments of the present application provide a delivery and storage device and a filament coiling device such that filament reels are held more neatly and space is utilized more reasonably, thereby increasing the number of filament reels stored. Moreover, the delivery and storage device and the filament coiling device are applicable to the external loading and unloading mechanism 260 for picking up and placing filament reels in the vertical direction.

The delivery and storage device can be employed to transfer a filament reel without a filament (hereinafter referred to as an empty filament reel) or transfer a filament reel wound with a filament (hereinafter referred to as a full filament reel) in the field of 3D printing, and can also be employed to store an empty filament reel or a full filament reel in the field of 3D printing, and meanwhile, can be employed to transfer and store filaments in various situations having a high requirement on filament reels other than the field of 3D printing, e.g., the field of filaments and cables, the field of nonferrous metal filaments, or the field of electronic filaments. It will be appreciated that the delivery and storage device of the present application is configured to transport filament reels or disc type materials similar to filament reels, which will not be limited here. Purely for the purpose of showing, the following description is made by taking a filament reel as an example in the present application.

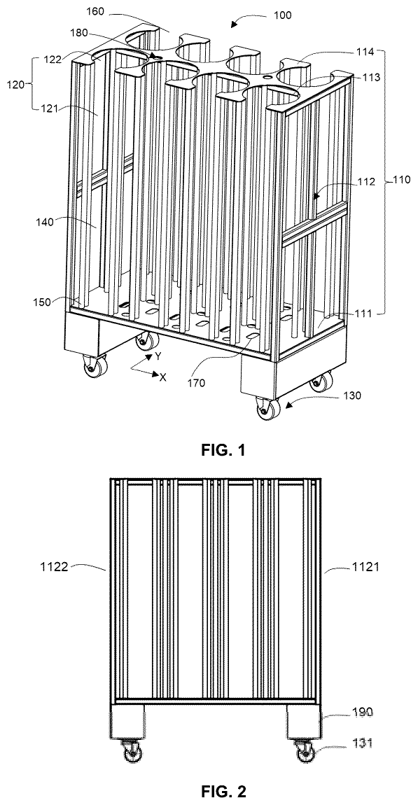

FIG. 1 illustrates a delivery and storage device. The delivery and storage device 100 includes a device body 110, a plurality of storage bins 120, and a traveling assembly 130. The device body 110 includes a chassis 111. The plurality of storage bins 120 are disposed on the chassis 111 and arranged in a direction parallel to the chassis 111. Further, the plurality of storage bins 120 are arranged in a two-dimensional array in a length direction X and a width direction Y of the delivery and storage device 100. The traveling assembly 130 is disposed on the chassis 111 to enable the device body 110 to roll and slide.

As shown in FIG. 1, each storage bin 120 includes a stacking cavity 121 and a pick-and-place opening 122 formed in a top of the stacking cavity 121. The stacking cavity 121 is capable of accommodating a plurality of filament reels stacked in a vertical direction within each stacking cavity 121. Due to the limitation of the stacking cavity 121, the filament reels cannot move in the direction parallel to the chassis. Since a plurality of storage bins arranged in the direction parallel to the chassis are employed to store filament reels, filament reels are held more neatly and space is utilized more reasonably. Accordingly, the number of filament reels stored can be increased. Also, since the filament reels are stacked in the vertical direction within the stacking cavity 121 without any structure such as a separator plate between two adjacent filament reels, when an external pick-and-place apparatus needs to pick up and place a filament reel, the external pick-and-place apparatus extends down into the stacking cavity 121 through the pick-and-place opening in the top of the stacking cavity 121 to grip or place a filament reel, and then moves up out of the stacking cavity 121. This is thus convenient for an external loading and unloading mechanism 260 to grip and place filament reels sequentially in the vertical direction. In addition, the stacking cavity 121 is capable of limiting the filament reels from moving in the direction parallel to the chassis. Therefore, the positions of the filament reels in the delivery and storage device are relatively fixed such that the external loading and unloading mechanism 260 grips the filament reels at the fixed positions each time. The positioning difficulty of automatic picking and placement is reduced.

There are a plurality of ways for selection to arrange the storage bins 120. For example, as shown in FIG. 1, the delivery and storage device may arrange 8 storage bins in 4 columns and 2 rows. Each storage bin is capable of 16 filament reels. The filament reels are sequentially stacked in the storage bin in the vertical direction. As a matter of course, other storage manners may also be selected according to production requirements. For example, 3, 4, 5, 6, 7, 9, or 10 storage bins may be provided. Each storage bin may also be designed to hold 5, 8, 9, 10, 15, 18, or 20 filament reels.

The pick-and-place opening 122 may be a circular opening or an opening in other shape. When the pick-and-place opening 122 is the circular opening, the shape of the pick-and-place opening 122 is identical to the shape of the stacking cavity 121 and the shape of the filament reel, facilitating picking and placement of a filament reel by the external loading and unloading mechanism 260. That is to say, when the external loading and unloading mechanism 260 picks up or place a filament reel, the circular pick-and-place opening 122 facilitates picking and placement by the external loading and unloading mechanism 260. That is, there are no edges and corners, and there is no problem of inconsistent edges and corners after rotation. Meanwhile, the pick-and-place opening 122 in the top plate 114 can limit the filament reels together with the stacking cavity 121 defined by a plurality of limiting elements 150. That is, when a stacking height of the filament reels reaches the pick-and-place opening 122, the pick-and-place opening 122 per se is a circular limiting mechanism to limit the filament reels 111 from moving in the direction parallel to the chassis. It needs to be appreciated that an inner diameter of the pick-and-place opening 122 may set according to an outer diameter of the filament reel as long as it is convenient for a filament reel to go in and out, which will not be limited here.

The pick-and-place opening 122 may not be a complete circle. As shown in FIG. 1, a communication opening 160 is disposed on a side of the pick-and-place opening 122 that corresponds to the heat exchange opening 140 and penetrates through an edge of the top plate 114 in a radial direction (i.e., the width direction Y) of the pick-and-place opening 122. It needs to be appreciated that the delivery and storage device 100 in the above embodiments may be applied to pick up or place a filament reel by the external loading and unloading mechanism 260 or manually. When a filament reel is picked up or placed manually, the provision of the communication opening 160 is convenient for a person to pick up or place the filament reel. When a filament reel is picked up or placed, a person can decide whether to pick up the filament reel through the pick-and-place opening 122 or through the communication opening 160 according to a distance between the filament reel and the pick-and-place opening 122 in the storage bin 120. For example, where the distance between the filament reel and the pick-and-place opening 122 in the storage bin 120 is less than or equal to a length of a person's arm, the person can easily pick up the filament reel through the pick-and-place opening 122. In this case, the person can select to pick up the filament reel through the pick-and-place opening 122. When the filament reel is picked up through the pick-and-place opening 122, the path of the person's arm picking up or placing the filament reel is similar to that of the external loading and unloading mechanism 260 picking up or placing the filament reel, both being vertically extending into the stacking cavity 121 through the pick-and-place opening 122 to pick up the filament reel.

For another example, where the distance between the filament reel and the pick-and-place opening 122 in the storage bin 120 is greater than the length of the person's arm, when the person picks up the filament reel through the pick-and-place opening 122, the length of the arm is insufficient to reach the position of the filament reel in the storage bin 120. In this case, the filament reel needs to be picked up with the aid of a tool. The working efficiency is low. Thus, the person can select to pick up the filament reel through the communication opening 160. When the filament reel is picked up through the communication opening 160, the person uses the hand to grasp the filament reel through the communication opening 160 and turns the filament reel from horizontal to vertical, and finally, takes out the vertical filament reel through the communication opening 160.

As shown in FIG. 1, the shape of the stacking cavity 121 is defined by a plurality of limiting elements 150. The plurality of limiting elements 150 may define a cylindrical stacking cavity 121 in a circumferential direction. The filament reel is usually cylindrical. The shape of the stacking cavity 121 is designed as a shape identical to that of the filament reel, and the inner diameter of the stacking cavity is designed to match the outer diameter of the filament reel. When a filament reel is placed into the stacking cavity 121, the plurality of limiting elements 150 are in contact with an edge of the filament reel, thus restricting the filament reel from moving in the direction parallel to the chassis 111. Therefore, the filament reel is more stable in a transfer process. The plurality of limiting elements 150 extend in a direction perpendicular to the chassis 111, and therefore, the stacking cavity 121 defined by the plurality of limiting elements 150 also extends in the direction perpendicular to the chassis 111. Therefore, when a plurality of filament reels are placed into the stacking cavity 121, the stacking cavity 121 may guide the filament reels such that central holes of the plurality of filament reels are coaxial, thereby facilitating gripping of the filament reels by the external pick-and-place apparatus through the central holes of the filament reels. It needs to be noted that a height of the plurality of limiting elements 150 extending in the direction perpendicular to the chassis 111 may be determined according to a specific use scenario of the delivery and storage device 100. For example, a moving distance of the external pick-and-place apparatus, a height limit of an arrangement space, and the like may be taken into account, which will not be limited here.

In order to allow a filament reel to be evenly acted upon by constraining forces from the plurality of limiting elements 150, as shown in FIG. 1, the plurality of limiting elements 150 are evenly distributed in the circumferential direction. In case of an emergency stop of the delivery and storage device or a bumpy road condition in the transfer process, the filament reel is acted upon by the constraining force from each limiting element 150 of the plurality of limiting elements 150. The constraining force from each limiting element 150 of the plurality of limiting elements 150 may be evenly distributed or unevenly distributed. When the constraining force from each limiting element 150 of the plurality of limiting elements 150 on the filament reel is evenly distributed, an inertia force in the direction parallel to the chassis 111 generated due to inertia of the filament reel in case of the emergency stop or the bumpy road condition may be evenly dispersed to each limiting element 150. The force acting on each limiting element 150 is reduced, and the carrying capacity of the whole stacking cavity 121 is improved. That is to say, in numerous arrangement patterns, the even distribution of the plurality of limiting elements 150 in the circumferential direction enables a force to act upon the filament reel more evenly such that the filament reel is more stable in the traveling process of the delivery and storage device 100.

The limiting element 150 may be of a columnar structure. In addition, in order to facilitate the storage and picking up of a filament reel, the limiting element 150 may be of a cylindrical structure. In this embodiment, the limiting element 150 is of the cylindrical structure and the filament reel is also of the cylindrical structure, side surfaces of two cylinders are in linear contact, and frictional force between the limiting element 150 and the filament reel is small so that the filament reel can be placed and picked up more easily. As a matter of course, limiting element structures with other cross-sectional shapes, such as a triangle, a rectangle, and a swallow-tail form, may also be selected according to production requirements.

Moreover, filaments in the field of 3D printing are mainly thermoplastic high polymer materials. Thermoplastic materials are hygroscopic and capable of absorbing water in the air. Water molecules will damage molecular chains of the thermoplastic high polymer materials and affect the quality of the filaments. The quality of the filaments may greatly affect the quality of printing. Therefore, the filaments need to be dried. The filaments are transported by the delivery and storage device for carrying filament reels. After an empty filament reel is wound filament a filament into a full filament reel, the filament reel is conveyed by the delivery and storage device 100 to an external drying apparatus for drying. Therefore, as shown in FIG. 1, a heat exchange opening 140 is formed in a sidewall of the stacking cavity 121. The heat exchange opening 140 serves for enabling the filament reels in the stacking cavity 121 to exchange heat with the outside of the stacking cavity 121. The heat exchange opening 140 may be formed in the sidewall in the length direction X of the chassis 111 or may be formed in the sidewall in the width direction Y of the chassis 111, or may be formed in both the sidewalls in the length direction X and the width direction Y of the chassis 111. The existence of the heat exchange opening 140 makes heat exchange between a filament reel and the outside possible. Thus, the range of use of the delivery and storage device 100 is expanded. At this point, the delivery and storage device 100 is not only a means of delivery for transferring a filament reel, but also a storage carrier for a filament reel during heat exchange.

The heat exchange opening 140 may be disposed in a plurality of ways. For example, as shown in FIG. 1, the heat exchange opening 140 is a penetrating heat exchange opening. That is, the heat exchange opening 140 penetrates the sidewall of the whole delivery and storage device 100 from the top of the stacking cavity 121 to the bottom of the stacking cavity 121. The external drying apparatus heats air such that hot air comes into contact with filaments through the penetrating heat exchange opening to dry the filaments. Due to a large heat exchange area, the penetrating heat exchange opening has the advantages of even heat convection, rapid heat convection, high thermal efficiency, and the like. For another example, a plurality of heat exchange openings 140 independent of one another are formed in a sidewall of the storage bin 120, and this structure may provide stronger overall structural strength of the storage bin 120.

It needs to be noted that the heat exchange opening 140 may be one heat exchange opening 140, or may be a plurality of heat exchange openings 140. When one heat exchange opening 140 is used, a temperature difference of heat exchange may be increased by increasing heat generated by the external drying apparatus, or the area of the heat exchange opening 140 is increased to improve the drying efficiency of filaments. When a plurality of heat exchange openings 140 are used, the drying efficiency of filaments can be improved by increasing a number of heat exchange openings 140. Moreover, the number of heat exchange openings 140 may be 1, 2, 3, 10, or the like, which will not be limited here.

As shown in FIG. 1, the stacking cavity 121 may be defined by the plurality of limiting elements 150. In this case, in order to form the heat exchange opening, a spacing between two adjacent limiting elements 150 may be appropriately increased such that the heat exchange opening 140 is formed between two adjacent limiting elements 150 of the plurality of limiting elements 150. It will be appreciated that the heat exchange opening 140 is not limited to be formed between the two adjacent limiting elements 150 of the plurality of limiting elements 150, and may also be formed in the sidewall of the delivery and storage device 100 or formed in the chassis 111. It needs to be appreciated that any communication opening 160 in the delivery and storage device 100 that is capable of enabling the filament reels within the stacking cavity 121 to exchange heat with the outside of the stacking cavity 121 may be used as the heat exchange opening 140.

As shown in FIG. 1, in addition to the chassis described above, the device body 110 may further include a top plate 114 disposed above the chassis 111 and a side support 112 located between the top plate 114 and the chassis 111. The top plate 114, the side support 112, and the chassis 111 define an external frame of the delivery and storage device. The external frame enables the delivery and storage device 100 to become a firm overall structure. The plurality of storage bins 120 may be disposed within the external frame. The pick-and-place opening 122 may be formed in the top plate 114. Thus, the storage bins 120 and the filament reels within the storage bins 120 can be protected effectively. The chassis 111 is configured to bear loads from the side support 112 and the stacking cavity 121 above the chassis 111. The side support 112 is configured to connect the chassis 111 and the top plate 114 to provide a support force for the top plate 114. The device body 110 may be made of low alloy steel, stainless steel, aluminum alloy, or the like that has high strength and low corrosion. A carrying manner for the device body 110 is carrying by the chassis 111. That is, the whole load or a large part of load of the device body 110 is born by the chassis 111

As shown in FIG. 1, the plurality of limiting elements 150 are located between the top plate 114 and the chassis 111, i.e., disposed to extend to the top plate 114 in the vertical direction on the chassis 111. Upper ends of the plurality of limiting elements 150 are connected to the top plate 114 and lower ends of the plurality of limiting elements 150 are connected to the chassis 111 such that the plurality of limiting rods are fixed between the top plate 114 and the chassis 111. The limiting rods 150 are avoided from tilting or displacement due to a too large load.

The upper and lower ends of the plurality of limiting elements 150 may be connected to the top plate 114 and the chassis 111 in a plurality of connection manners. For example, the upper and lower ends of the plurality of limiting elements 150 may be connected to the top plate 114 and the chassis 111 in a detachable connection manner. The detachable connection manner facilitates replacing the limiting element 150 at any time. During replacement, other structures in the delivery and storage device 100 may not be damaged. It is avoided that the whole delivery and storage device 100 cannot run due to a failure of a certain limiting element 150 among the plurality of limiting elements 150. The detachable connection manner may be at least one of threaded connection, snap-fit connection, and hinged connection. It needs to be noted that the upper and lower ends of the plurality of limiting elements 150 may be connected to the top plate 114 and the chassis 111 in the same detachable connection manner. For example, the upper and lower ends of the plurality of limiting elements 150 may be connected to the top plate 114 and the chassis 111 by threaded connection. They may also be connected to the top plate 114 and the chassis 111 in different detachable connection manners. For example, the upper ends of the plurality of limiting elements 150 are connected to the top plate 114 and the chassis 111 by threaded connection, and the lower ends of the plurality of limiting elements 150 are connected to the top plate 114 and the chassis 111 by snap-fit connection.

For another example, the upper and lower ends of the plurality of limiting elements 150 may be connected to the top plate 114 and the chassis 111 in a non-detachable connection manner. The non-detachable connection manner has high connection strength and can further increase the load of the delivery and storage device 100. Meanwhile, the mounting is simple. The non-detachable connection may be at least one of edge folded connection, riveted connection, bonded connection, and welded connection. It needs to be noted that the upper and lower ends of the plurality of limiting elements 150 may be connected to the top plate 114 and the chassis 111 in the same non-detachable connection manner. For example, the upper and lower ends of the plurality of limiting elements 150 may be connected to the top plate 114 and the chassis 111 by welded connection. They may also be connected to the top plate 114 and the chassis 111 in different non-detachable connection manners. For example, the upper ends of the plurality of limiting elements 150 are connected to the top plate 114 and the chassis 111 by welded connection, and the lower ends of the plurality of limiting elements 150 are connected to the top plate 114 and the chassis 111 by riveted connection.

It needs to be noted that the upper and lower ends of the plurality of limiting elements 150 may be connected to the top plate 114 and the chassis 111 in the same connection manner, or may be connected to the top plate 114 and the chassis 111 in different connection manners. For example, the upper ends of the plurality of limiting elements 150 are connected to the top plate 114 and the chassis 111 in a detachable connection, and the lower ends of the plurality of limiting elements 150 are connected to the top plate 114 and the chassis 111 by in a non-detachable connection manner.

As shown in FIG. 1 and FIG. 2, the side support 112 includes a first support frame 1121 and a second support frame 1122. The first support frame 1121 and the second support frame 1122 are disposed face to face. The top plate 114 is located between the first support frame 1121 and the second support frame 1122. Two ends of the top plate 114 are lapped on the first support frame 1121 and the second support frame 1122, respectively. The two ends of the top plate 114 may be detachably or non-detachably lapped on the first support frame 1121 and the second support frame 1122.

When a lapping manner of the top plate 114 and the side support 112 is detachable connection, the top plate 114 may be replaced at any time. It is avoided that the whole delivery and storage device 100 cannot run due to a failure of the top plate 114. The detachable connection may be one of threaded connection, snap-fit connection, and hinged connection. When the lapping manner of the top plate 114 and the side support 112 is non-detachable connection, the connection of the top plate 114 and the side support 112 is more secure. The non-detachable connection may be one of edge folded connection, riveted connection, bonded connection, and welded connection.

As shown in FIG. 1 and FIG. 2, both the first support frame 1121 and the second support frame 1122 located between the top plate 114 and the chassis 111 are rectangular frames composed of a plurality of cross rods and a plurality of upright rods. The chassis 111 is located between the first support frame 1121 and the second support frame 1122. The stacking cavity 121 is disposed within a space formed by the first support frame 1121, the chassis 111, and the second support frame 1122. The plurality of cross rods are connected between two adjacent ones of the plurality of upright rods. The cross rods are used to connect and reinforce the adjacent upright rods connected with the cross rods such that the overall structure of the delivery and storage device 100 is more secure. Gaps formed between the plurality of upright rods and the plurality of cross rods may be used as heat exchange openings, and meanwhile, the weight of the delivery and storage device 100 per se is reduced.

As shown in FIG. 1, the device body 110 further includes a cross beam 113. One end of the cross beam 113 is connected to the top of the first support frame 1121, and the other end of the cross beam 113 is connected to the top of the second support frame 1122. The top plate 114 may be lapped on the cross beam 113, and a pick-and-place opening 122 is formed in the top plate 114. The cross beam 113 provides a support force for the top plate 114. When the top plate 114 is lapped on the first support frame 1121 and the second support frame 1122 through the cross beam 113. The existence of the cross beam 113 improves the stability of the top plate 113, preventing the top plate 113 from deformation. A connection manner of the top plate 114 and the cross beam 113 may be welding, riveted connection, threaded connection, clamping, or the like.

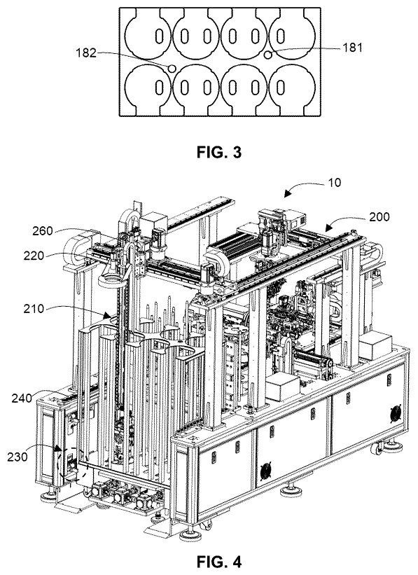

When the way of picking up or placing a filament reel is picking up or placing by the external loading and unloading mechanism 260, as shown in FIG. 1 and FIG. 3, a locating identifier 180 for identification by the external loading and unloading mechanism 260 is disposed on the top plate 114. The locating identifier 180 is configured for the external loading and unloading mechanism 260 to identify the position of the delivery and storage device 100. The locating identifier 180 may be a circular hole, a protrusion, a texture, a label, or the like, which will not be limited here. During identification, the external loading and unloading mechanism 260 is capable of converting an optical image of the locating identifier 180 into a digital signal which is compressed and then transmitted to a controller within the external loading and unloading mechanism 260. The controller controls the external loading and unloading mechanism 260 to move, fall, rise, or the like as required, to move the external loading and unloading mechanism 260 to the position of a filament reel.

The number of locating identifiers 180 may be one, two or more. When one locating identifier 180 is used, the controller within the external loading and unloading mechanism 260 may preset coordinate values of an outline of the delivery and storage device 100 with the locating identifier 180 as an origin of coordinates. That is, the external loading and unloading mechanism 260 takes a photo and identifies the locating identifier 180, establishes a coordinate system with the identified locating identifier 180 as the origin of coordinates, and transfers the information of the coordinate system to the controller within the external loading and unloading mechanism 260. The controller within the external loading and unloading mechanism 260 determines the external outline of the delivery and storage device 100 with the origin of coordinates, preset horizontal coordinate values, and preset vertical coordinate values, thereby determining the position of the delivery and storage device 100. It needs to be appreciated that a size of the delivery and storage device 100 and a position of the locating identifier 180 may be fixed or variable. When the size of the delivery and storage device 100 and the position of the locating identifier 180 vary, the preset coordinate values of the outline of the delivery and storage device 100 in the controller within the external loading and unloading mechanism 260 may be changed.

Two locating identifiers 180 may be used. As shown in FIG. 3, the locating identifiers 180 include a first locating identifier 181 and a second locating identifier 182. The external loading and unloading mechanism 260 takes a photo and identifies the first locating identifier 181, establishes a coordinate system with the identified first locating identifier 181 as the origin of coordinates, and transfers the information of the coordinate system to the controller within the external loading and unloading mechanism 260. Next, the external loading and unloading mechanism 260 takes a photo and identifies the second locating identifier 182, determines coordinate values of the second locating identifier 182 based on the identified coordinate system, and transfers the information of the coordinate system to the controller within the external loading and unloading mechanism 260. The controller within the external loading and unloading mechanism 260 determines the external outline of the delivery and storage device 100 with the first locating identifier 181 and the second locating identifier 182, thereby determining the position of the delivery and storage device 100. It needs to be appreciated that the external loading and unloading mechanism 260 may establish a coordinate system with the first locating identifier 181 as the origin of coordinates, or may establish a coordinate system with the second locating identifier 182 as the origin of coordinates. Furthermore, the size of the delivery and storage device 100 and the position of the locating identifier 180 may be fixed or variable. When the size of the delivery and storage device 100 and the position of the locating identifier 180 vary, it may have no influence on the controller within the external loading and unloading mechanism 260 determining the external outline of the delivery and storage device 100 with the first locating identifier 181 and the second locating identifier 182.

A connecting line of the first locating identifier 181 and the second locating identifier 182 is tilted relative to both a length direction X and a width direction Y of the top plate 114. That is, the coordinate values of the delivery and storage device 100 in the length direction X and the width direction Y may be obtained in such a manner that the connecting line of the first locating identifier 181 and the second locating identifier 182 is tilted relative to the length direction X and the width direction Y of the top plate 114. It is avoided that the external loading and unloading mechanism 260 only identifies the coordinate value of the delivery and storage device 100 in the length direction X or the width direction Y because a straight line of the first locating identifier 181 and the second locating identifier 182 is perpendicular to the length direction X and the width direction Y of the top plate 114.

When the chassis 111 is of a plate-like structure, at least one lightening hole 170 is formed in the chassis 111 to reduce the weight of the delivery and storage device 100. A shape of the lightening hole 170 may be at least one of a circle, an ellipse, a square, a triangle, or a rounded rectangle. The lightening holes 170 of a plurality of shapes ensure a maximum utilization rate of the space of the chassis 111. That is, after the plurality of limiting elements 150 have been arranged as required, the lightening holes 170 of different shapes may be formed in the residual space other than the limiting elements 150 on the chassis 111 such that the weight is reduced reasonably while the function of the chassis 111 is kept unchanged. For example, an elliptical lightening hole 170 may be formed in the vicinity of a limiting rod 150, and triangular lightening holes 170 may be formed in four corners of the chassis 111. It should be understood that a specific number and a shape of the lightening holes 170 are decided by a size of the chassis 111 and a number of limiting elements 150, which will not be limited here.

As shown in FIG. 2, a heightening seat 190 is further disposed at the bottom of the chassis 111 of the delivery and storage device 100. The heightening seat 190 is configured to increase a distance between the chassis 111 and a ground so as to avoid an obstacle in a conveying process of the delivery and storage device 100.

In addition, as shown in FIG. 2, the traveling assembly 130 may be a roller 131. In this embodiment, the delivery and storage device 100 is of a cuboid structure. Therefore, in order to maintain a balance of the overall device body 110 and facilitate moving the delivery and storage device 100 by a worker, rollers 131 are disposed at four corners of the bottom. It needs to be appreciated that the rollers 131 may be directly connected to the chassis 111, or may be connected to the chassis 111 through the heightening seat 190. Specifically, the roller 131 may be one of a one-way wheel, a universal wheel, and an aircraft wheel. A brake structure may further be disposed on the roller 131 to stop the roller 131 from rolling. The number of rollers 131 is set according to the size and loading capacity of the delivery and storage device 100, which will not be limited here.

The traveling assembly 130 may also be of a structure of a slider and a guide rail matching each other. Guide rails may be mounted on the ground on both sides of a station of the delivery and storage device 100, and sliders are mounted on the chassis 111. The sliders match the guide rails to support the movement of the whole delivery and storage device 100. It needs to be appreciated that the sliders may be disposed in the length direction X of the chassis 111, or may be disposed in the width direction Y of the chassis 111, and the guide rails may be disposed according to an actual application scenario. Moreover, the rollers 131 may be directly connected to the chassis 111, or may be connected to the chassis 111 through the heightening seat 190. The number of sliders is set according to the size and loading capacity of the delivery and storage device 100, which will not be limited here.

FIG. 4 and FIG. 6 illustrate a filament coiling device 10. In addition to the delivery and storage device 100 described above, an embodiment of the present application further provides a filament coiling device 10. The filament coiling device 10 includes a rack 200, a delivery and storage device 100, and a loading and unloading mechanism 260. The rack 200 includes a loading and unloading station 210. The delivery and storage device 100 is disposed in the loading and unloading station 210. The delivery and storage device 100 is the delivery and storage device 100 mentioned in any of the above-mentioned embodiments. The loading and unloading mechanism 260 is disposed on the rack such that the loading and unloading mechanism 260 picks up a filament reel in a stacking cavity of the delivery and storage device or place a filament reel in the stacking cavity in a vertical direction.

A locking mechanism 230 is disposed between the rack 200 and the delivery and storage device 100 and configured to lock a position of the delivery and storage device 100 when the delivery and storage device 100 enters the loading and unloading station 210, thereby preventing the delivery and storage device 100 from moving to affect the accuracy of picking up or placement when the loading and unloading mechanism 260 picks up or places a filament reel. The locking mechanism 230 may be a screw locking apparatus, a clamping locking apparatus, a sliding locking apparatus, a torsional spring locking apparatus, or the like. For the purpose of showing, this embodiment is described by taking the clamping locking apparatus as an example.

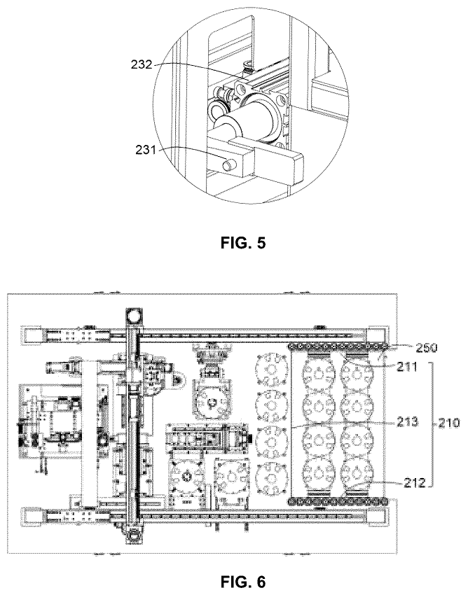

FIG. 5 illustrates a partial enlarged view of a locking mechanism. The locking mechanism 230 includes a stop arm 231 and a locking actuator 232 disposed at an access opening 250. The stop arm 231 is capable of moving between a locking position and an unlocking position. When the stop arm 231 is located in the locking position, the stop arm 231 obstructs the delivery and storage device 100 to prevent the delivery and storage device 100 from moving out of the access opening 250; and when the stop arm 231 is located in the unlocking position, the stop arm 231 avoids the delivery and storage device 100, and the delivery and storage device 100 can move freely. The locking actuator 232 is configured to drive the stop arm 231 between the locking position and the unlocking position.

The stop arm 231 may move between the locking position and the unlocking position in a plurality of manners. For example, the stop arm 231 may move in a rotating manner. The delivery and storage device 100 is prevented from moving out of the access opening 250 by the rotation of the stop arm 231. That is, when the stop arm 231 rotates to a vertical state, the stop arm 231 keeps away from a traveling route of the delivery and storage device. In this case, the delivery and storage device 100 can move out of the access opening 250. When the stop arm 231 rotates to a horizontal state, the stop arm 231 obstructs the traveling route of the delivery and storage device. In this case, the stop arm 231 can prevent the delivery and storage device 100 from moving out of the access opening 250. Further, when the stop arm 231 is rotatably disposed at the access opening 250, the locking actuator 232 is configured to drive the stop arm 231 to rotate between the locking position and the unlocking position.

For another example, the stop arm 231 may move in a sliding manner. The delivery and storage device 100 is prevented from moving out of the access opening 250 by the sliding of the stop arm 231. That is, when the stop arm 231 rotates to the horizontal state, the stop arm 231 obstructs the traveling route of the delivery and storage device. In this case, the stop arm 231 can prevent the delivery and storage device 100 from moving out of the access opening 250. When the stop arm 231 rotates to a horizontal state, the stop arm 231 keeps away from the traveling route of the delivery and storage device. In this case, the delivery and storage device 100 can move out of the access opening 250. Further, when the stop arm 231 is rotatably disposed at the access opening 250, the locking actuator 232 is configured to drive the stop arm 231 to slide between the locking position and the unlocking position.

As shown in FIG. 6, the loading and unloading station 210 includes a first sidewall 211, a second sidewall 212, and a third sidewall 213. The first sidewall 211 and the second sidewall 212 are disposed relatively. The third sidewall 213 is connected between the first sidewall 211 and the second sidewall 212. The access opening 250 is formed at ends of the first sidewall 211 and the second sidewall 212 away from the third sidewall 213. The delivery and storage device 100 enters the loading and unloading station 210 through the access opening 250. When the delivery and storage device 100 is located in the loading and unloading station 210, the delivery and storage device 100 abuts against the first sidewall 211, the second sidewall 212, and the third sidewall 213 separately. The locking mechanism 230 is disposed at the access opening 250. When the locking mechanism 230 is in a locked state, the locking mechanism 230 can prevent the delivery and storage device 100 from moving out of the access opening 250. When the locking mechanism 230 is in an unlocked state, the delivery and storage device 100 can move freely out of the access opening 250. It needs to be appreciated that the number of locking mechanisms 230 may be one, or two or more. A specific position of the locking mechanism 230 may be determined according to an actual application scenario, which will not be limited here.

As shown in FIG. 4, a plurality of rollers 240 are further disposed on the first sidewall 211 and the second sidewall 212. The plurality of rollers 240 are arranged in a moving direction of the delivery and storage device 100. A frictional force of the delivery and storage device 100 moving in and out of the loading and unloading station 210 is reduced by means of the rollers 240 such that it is more labor saving when the delivery and storage device 100 moves in and out of the loading and unloading station 210.

A locating identifier 180 is disposed on a top plate 114 of the delivery and storage device 100. As shown in FIG. 4, the rack 200 further includes an identifying apparatus 220. When the delivery and storage device 100 reaches the loading and unloading station 210, the identifying apparatus 220 in the filament coiling device 10 is capable of determining an external outline of the delivery and storage device 100 to determine a position of the delivery and storage device 100 by photographing the locating identifier 180 and determining coordinates of the locating identifier 180.

In summary, after reading this detailed disclosure, those skilled in the art can understand that the foregoing detailed disclosure may be presented by way of example only, and may not be limited. Although there is no clear description, those skilled in the art can understand that this application intends to cover various reasonable changes, improvements and modifications of the embodiments. These changes, improvements and modifications are intended to be proposed by the present disclosure, and fall within the spirit and scope of the exemplary embodiments of the present disclosure.

In addition, some specific terms in this application have been used to describe the embodiments of this application. For example, “one embodiment”, “an embodiment” and/or “some embodiments” mean that a specific feature, structure, or characteristic described in combination with the embodiment may be included in at least one embodiment of the present application. Therefore, it can be emphasized and should be understood that two or more references to “an embodiment” or “one embodiment” or “an alternative embodiment” in various parts of this specification do not necessarily all refer to the same embodiment. In addition, specific feature, structure, or characteristic may be appropriately combined in one or more embodiments of the present application.

It should be understood that in the foregoing description of the embodiments of the present application, to help understand a feature, and for the purpose of simplifying the present application, the present application sometimes combines various features in a single embodiment, a drawing, or description thereof. Alternatively, this application disperses various features in multiple embodiments of the present invention. However, this does not mean that the combination of these features is necessary. It is entirely possible for those skilled in the art to extract some of the features as a single embodiment for understanding when reading this application. In other words, the embodiments in this application can also be understood as an integration of multiple sub-embodiments. The content of each sub-embodiment is also true when it is less than all the characteristics of a single previously disclosed embodiment.

In some embodiments, numbers expressing quantities or properties and used to describe and claim protection of certain embodiments of this application should be understood as modified by the terms “about”, “approximately” or “substantially” in some cases. For example, unless otherwise stated, “about”, “approximately” or “substantially” may mean a ±20% variation of the value described. Therefore, in some embodiments, the numerical parameters listed in the written description and appended claims are approximations, which may vary according to the desired properties that a specific embodiment attempts to achieve. In some embodiments, the numerical parameters should be interpreted based on the number of significant figures reported and by applying common rounding techniques. Although some embodiments described in this application list a wide range of numerical ranges and the parameters are approximate values, the specific examples all list numerical values as precise as possible.

Each patent, patent application, patent application publication and other materials cited herein, such as articles, books, specifications, publications, documents, articles and the like, may be incorporated herein by reference. The entire content used for all purposes, except for any related litigation document history, may be inconsistent or conflicting with this document, or any identical litigation document that may have restrictive influence on the broadest scope of the claims' history. Those are associated with this document now or in the future. For example, if the description, definition, and/or use of terms in any associated materials contained herein is inconsistent with or in conflict with that in this document, the terms in this document shall prevail.

Finally, it should be understood that the embodiment of the application disclosed herein is an explanation of the principle of the embodiment of the application. Other modified embodiments are also within the scope of this application. Therefore, the embodiments disclosed in this application are merely examples rather than limitations. Those skilled in the art can adopt alternative configurations according to the embodiments of the present application to implement the disclosure in this application. Therefore, the embodiments of the present application are not limited to those exactly described in the application.

What is claimed is:

1. A delivery and storage device configured to load a filament reel, comprising:
a device body including a chassis;
a plurality of storage bins disposed on the chassis and arranged in a direction parallel to the chassis, wherein each of the storage bins includes a stacking cavity and a pick-and-place opening formed in a top of the stacking cavity; and the stacking cavity is configured to accommodate filament reels stacked in a direction perpendicular to the chassis and restrict the filament reels from moving in the direction parallel to the chassis;
a traveling assembly disposed on the chassis to enable the device body to roll or slide.

2. The delivery and storage device according to claim 1, wherein a heat exchange opening is formed in a sidewall of the stacking cavity and configured to enable the filament reels in the stacking cavity to exchange heat with the outside.

3. The delivery and storage device according to claim 2, wherein the heat exchange opening extends from the top of the stacking cavity to a bottom of the stacking cavity.

4. The delivery and storage device according to claim 2, wherein the stacking cavity is defined by a plurality of limiting elements in a circumferential direction; the plurality of limiting elements extend in the direction perpendicular to the chassis; and the heat exchange opening is formed between two adjacent ones of the plurality of limiting elements.

5. The delivery and storage device according to claim 4, wherein the limiting element is of a columnar structure, or the plurality of limiting elements are evenly distributed in the circumferential direction.

6. The delivery and storage device according to claim 4, wherein the device body further includes:
a top plate located above the chassis, wherein the pick-and-place opening is formed in the top plate; and
a side support located between the chassis and the top plate to connect the chassis and the top plate,
wherein the plurality of limiting elements are located between the top plate and the chassis; upper ends of the plurality of limiting elements are connected to the top plate; and lower ends of the plurality of limiting elements are connected to the chassis.

7. The delivery and storage device according to claim 6, wherein the side support includes a first support frame and a second support frame disposed oppositely; and two ends of the top plate are lapped on the first support frame and the second support frame, respectively.

8. The delivery and storage device according to claim 7, wherein the device body further includes a cross beam which has one end connected to a top of the first support frame and the other end connected to a top of the second support frame; and the top plate is lapped on the cross beam.

9. The delivery and storage device according to claim 6, wherein a communication opening is disposed on a side of the pick-and-place opening that corresponds to the heat exchange opening and penetrates through an edge of the top plate in a radial direction of the pick-and-place opening.

10. The delivery and storage device according to claim 6, wherein a locating identifier is disposed on the top plate; the locating identifier includes a first locating identifier and a second locating identifier; a connecting line of the first locating identifier and the second locating identifier is tilted relative to both a length direction and a width direction of the top plate; and the first locating identifier and the second locating identifier are configured for an external loading and unloading mechanism to identify a position of the delivery and storage device.

11. The delivery and storage device according to claim 1, wherein an inner diameter of the stacking cavity matches an outer diameter of the filament reel; and the plurality of storage bins are arranged in a two-dimensional array in a length direction and a width direction of the delivery and storage device.

12. The delivery and storage device according to claim 1, wherein at least one lightening hole is formed in the chassis.

13. The delivery and storage device according to claim 1, wherein a heightening seat is disposed at a bottom of the chassis and configured to increase a distance between the chassis and a ground; and
the traveling assembly includes:
a roller disposed at a bottom of the heightening seat, wherein a brake apparatus is disposed on the roller.

14. A filament coiling device, comprising:
a rack including a loading and unloading station;
a delivery and storage device disposed at the loading and unloading station, wherein the delivery and storage device is the delivery and storage device according to claim 1; and
a loading and unloading mechanism disposed on the rack and configured to pick up a filament reel in a stacking cavity of the delivery and storage device or place a filament reel in the stacking cavity in a vertical direction.

15. The filament coiling device according to claim 14, wherein a locking mechanism is disposed between the rack and the delivery and storage device and configured to lock a position of the delivery and storage device when the delivery and storage device enters the loading and unloading station.

16. The filament coiling device according to claim 15, wherein the loading and unloading station includes a first sidewall, a second sidewall, and a third sidewall; the first sidewall and the second sidewall are disposed oppositely; the third sidewall is connected between the first sidewall and the second sidewall; an access opening is formed at ends of the first sidewall and the second sidewall away from the third sidewall; the delivery and storage device enters the loading and unloading station through the access opening, and when the delivery and storage device is located in the loading and unloading station, the delivery and storage device abuts against the first sidewall, the second sidewall, and the third sidewall separately; the locking mechanism is disposed at the access opening; and when the locking mechanism is in a locked state, the locking mechanism prevents the delivery and storage device from moving out of the access opening.

17. The filament coiling device according to claim 16, wherein a plurality of rollers are disposed on the first sidewall and the second sidewall; the plurality of rollers are arranged in a moving direction of the delivery and storage device to guide the delivery and storage device to move into and out of the loading and unloading station and reduce a frictional force of the delivery and storage device.

18. The filament coiling device according to claim 16, wherein the locking mechanism includes:
a stop arm disposed at the access opening and configured to be movable between a locking position and an unlocking position, wherein when the stop arm is located in the locking position, the stop arm obstructs the delivery and storage device to prevent the delivery and storage device from moving out of the access opening; and when the stop arm is located in the unlocking position, the stop arm avoids the delivery and storage device; and
a locking actuator configured to drive the stop arm to move between the locking position and the unlocking position.

19. The filament coiling device according to claim 18, wherein the stop arm is rotatably disposed at the access opening; and the locking actuator is configured to drive the stop arm to rotate between the locking position and the unlocking position.

20. The filament coiling device according to claim 14, wherein,
a locating identifier is disposed on a top plate of the delivery and storage device; and an identification apparatus is disposed on the loading and unloading mechanism and configured to identify the locating identifier to determine a position of the delivery and storage device.
